(19) United States
(12) Patent Application Publication
(10) Pub. No.: US 2010/0072320 A1
(43) Pub. Date: Mar. 25, 2010

(54) PROGRAMMABLE AERIAL REFUELING RANGE

(76) Inventor: ASHER BARTOV, BEVERLY HILLS, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/237,305

(22) Filed: Sep. 24, 2008

(51) Int. Cl. B64D 39/00

(52) U.S. Cl. 244/135 A

(57) ABSTRACT

In an aerial refueling system for refueling a receiver aircraft in flight from a tanker aircraft, wherein the refueling system includes a hose reel rotatably coupled to the tanker aircraft's fuselage, a hose wound around the reel, said hose having an outlet end, and a drogue affixed to said outlet end, a hose reel drive system including a microprocessor electrically coupled to the reel; and a machine-readable program embodied in the microprocessor for directing operation of the system, the machine-readable program including instructions for establishing a refueling range. A method including receiving information of a receiver aircraft for aerial refueling; and establishing, in flight, a refueling range for an aerial refueling system coupled to a tanker aircraft based on the received information.

### 1. FIELD

Aerial refueling of aircraft from tanker aircraft having a reel-mounted hose and drogue system.

### 2. BACKGROUND

Aerial refueling of one aircraft from a flying tanker aircraft has become a fairly common event. Nevertheless, aerial refueling is still a difficult and dangerous maneuver and is typically attempted only by military pilots in military aircraft.

Today, two types of aerial refueling systems are used by the various militaries throughout the world. One is an extendible boom system and the other is a hose and drogue system. The invention relates to the latter type system.

In a hose and drogue system, the drogue is attached to the outlet end of a hose. The inlet end of the hose is attached to a reel onto which the hose is wound. The reel is typically mounted either within the tanker aircraft's fuselage or on a refueling pod or module which is attached to the bottom of the tanker aircraft. When the hose is deployed, the outlet end of the hose, with its attached drogue, extends behind the tanker aircraft. Depending upon the combinations of tanker and receiver aircraft and the specifications of the particular refueling system used, the length of the hose may be 50 feet or more (e.g., 93 feet for a hose of a C130 tanker aircraft), and the drogue is in a preferred refueling range when it is extending minimum 20 feet from the stowed position.

When the hose and drogue are in the fully extended position (with some hose still remaining on the reel), the pilot of the aircraft to be refueled maneuvers his or her aircraft into a position such that the refueling probe of the receiver aircraft enters into and engages with the drogue. Such an engagement may cause contact of mating surfaces of the drogue and probe that may be sufficient to allow fuel to pass from the drogue to the probe at an acceptable flow rate and without an unacceptable amount of leakage. The pilot continues to urge the receiver aircraft forward relative to the tanker aircraft until the drogue is in the refueling range. As the receiver aircraft is moving forward, the hose is retracted onto the reel to take up the slack in the hose. A refueling range marker is disposed on a predetermined portion of the hose. When the pilot of the receiver aircraft sees the refueling range marker reenter the tanker aircraft's fuselage or refueling pod, the receiver aircraft's pilot knows that the drogue, engaged with the receiver aircraft's probe, is in the refueling range. When the engaged drogue and probe are in the refueling range, fuel is pumped from the tanker aircraft to the receiver aircraft. After refueling is completed, the pilot of the receiver aircraft reduces its speed relative to the tanker aircraft. The hose and drogue are pulled back with the probe of the receiver aircraft, with the hose again being unwound from the reel, until the drogue and hose reach the fully extended position. At this point rotation of the reel stops, the drogue and hose cannot be pulled further back, and the receiver aircraft's refueling probe disengages from the drogue (e.g., disengage mating surfaces of and remove the probe from the drogue). Retraction of the hose back onto the reel then begins.

A typical refueling range begins after the receiver aircraft pushes the hose approximately five feet in the retract direction toward the tanker aircraft and ends a predetermined distance (e.g., a minimum of 20 feet) from a stowed position. Some systems have two refueling ranges for receiver aircraft: approximately 20 feet for helicopters and approximately 60 feet for fixed wing aircraft. If the receiver aircraft pushes the hose too close to the tanker aircraft or pulls it away beyond the refueling range (i.e., more than 20 feet for helicopters or more than 60 feet for fixed wing aircraft), refueling stops (e.g., using a cutoff switch) until the receiver aircraft repositions itself within refueling range relative to the tanker aircraft. To change a refueling range requires an adjustment on the ground to the tanker aircraft. Thus, to accommodate a low speed refueling and a subsequent high speed refueling, or vice versa, the tanker aircraft must land for refitting of a different refueling drogue configuration and to change the refueling range.

### BRIEF DESCRIPTION OF THE DRAWINGS

Features, aspects, and advantages of embodiments will become more thoroughly apparent from the following detailed description, appended claims, and accompanying drawings in which:

FIG. 1 is a schematic view of an embodiment of a hose reel control system.

FIG. 2 is a flow chart describing a method for establishing a refueling range.

FIG. 3 is a flow chart describing a method for modifying a refueling range.

### DETAILED DESCRIPTION

Hose reel systems and methods are described that offer the ability to establish and/or change a refueling range while a tanker aircraft is in flight. In one embodiment, a refueling range is established by a microprocessor (controller) on a tanker aircraft in response to receiving data about a receiver aircraft. By using a microprocessor to establish and control a refueling range, multiple refueling ranges are available to a tanker aircraft. A refueling system may have a variable drag drogue (VDD) that can be used for a wide range of airspeeds and therefore for a wide range of receiver aircraft, which may require changes to the refueling range to be made in flight.

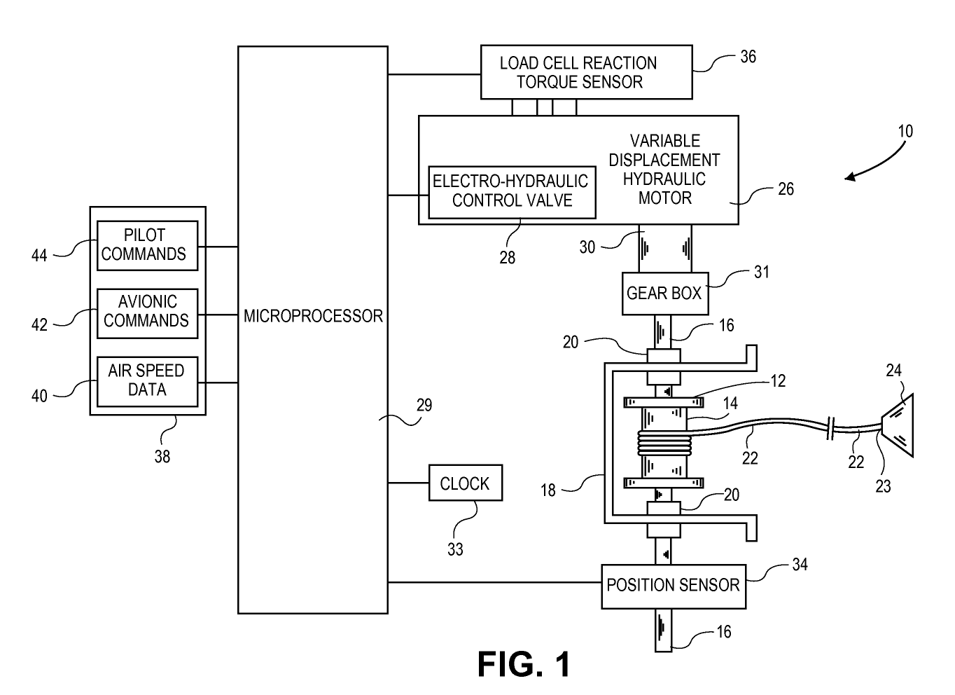

One embodiment of a hose reel drive system 10 is shown in FIG. 1. The hose reel drive system described with reference to FIG. 1 includes a variable displacement motor. It is appreciated that the system and method for establishing and controlling a refueling range including systems and method that offer multiple refueling ranges can alternatively be implemented in hose reel drive systems using other motors and/or pumps, such as hydraulic motors/pumps of the fixed displacement type or systems using electric (e.g., direct current) motors/generators.

A hose reel 12 is shown. It includes drum 14 around which hose 22 is wound. In FIG. 1, the hose is shown in a partially-deployed position. Drogue 24 is attached to the free or outlet end 23 of the hose. The hose reel is mounted on reel drive shaft 16, which is mounted on housing 18 and rotates with respect to housing 18 by means of bearing boxes 20. Housing 18 may be affixed to the interior of a tanker aircraft's fuselage or to a refueling pod or module which is attached to the bottom of the tanker aircraft. (In either event, the hose reel is mounted, either directly or indirectly, on the tanker aircraft's fuselage.) The inlet end of the hose is attached to the drum and is connected to the tanker aircraft's refueling supply in any of the ways known to designers of tanker refueling configurations. In fact, in some embodiments, the hose reel, drum, hose, drogue, reel drive shaft, housing and bearing boxes may all be configured as is already done in the prior art.

The hose reel drive system illustrated in FIG. 1 includes in this embodiment a variable displacement hydraulic motor 26 having an electro-hydraulic control valve 28. The spline shaft 30 of the motor is connected to gear box 31 which in turn is connected to an end of reel drive shaft 16. The gear box connects and translates rotation of the spline shaft to the reel drive shaft at a speed reduction ratio of about 40 to 1.

The variable displacement hydraulic motor may be selected from such motors offered for sale by manufacturers of hydraulic motors. Depending upon the specifications relating to the size and weight of the reel drive shaft, reel, hose and drogue, the reduction gear ratio and the speeds at which the reel is to be operated, the sizes of certain parts of the motor may have to be customized.

The torque at which the motor drives its spline shaft is controlled by electro-hydraulic control valve 28. By way of a summary description, the electro-hydraulic control valve 28 increases or decreases the pressure of hydraulic fluid within a spring-biased displacement control piston in the motor. The hydraulic pressure in the control piston causes that piston to move into a position corresponding to such pressure. The position of the control piston determines the motor displacement, which in turn determines the output torque exerted by the spline shaft at a given hydraulic pressure supplied to the motor. The particular motor displacement and the maximum available hydraulic flow to the motor determine the maximum motor speed (i.e., the output speed of the spline shaft measured in revolutions per minute). Electro-hydraulic control valve 28 is itself controlled by electronic signals from microprocessor 29 to which it is electrically connected. For example, such electronic signals may cause the motor to extend, stop, or retract hose as noted herein, such as by contracting movement of the piston.

In some embodiments, microprocessor 29 is programmed to send appropriate control signals to electro-hydraulic control valve 28 depending upon the hose and drogue configuration, the direction and/or the speed of their travel relative to the reel, and forces on them. Microprocessor 29 has an internal clock and/or is connected to an external clock 33. The microprocessor is also electrically connected to the tanker aircraft's controls 38 so that microprocessor 29 receives flight data such as air speed data 40 and command instructions (e.g., deploy hose and drogue, and retract hose and drogue) initiated by the tanker aircraft's pilot 42 or by avionic equipment 44.

Microprocessor 29 receives data indicating the position of the hose (i.e., how far the drogue is extended from the reel) and the speed and direction in which the hose is traveling, provided by position sensor 34 which is electrically connected to the microprocessor. In one embodiment, position sensor 34 is mechanically connected to reel drive shaft 16. Alternatively, the position sensor module may be connected to reel 12. It will be appreciated by those skilled in the art that position sensor 34 may be a tachometer or a position sensor or both, with the speed of the reel drive shaft and its angular position being mathematically related to each other as a function of elapsed time. In addition, elapsed time and the reel drive shaft's speed or angular position are mathematically related to the linear speed (e.g., at feet per second) at which the hose and drogue are being extended or retracted and their instant position, depending upon the particular geometry (e.g., drum and hose diameters) of the reel and hose.

Microprocessor 29 receives data relating to the reaction torque on the reel (i.e., as a result of contact of the receiver aircraft's refueling probe with the drogue and/or air stream effects therebetween) from reaction torque sensor 36, which in one embodiment is a load cell, which is electrically connected to provide the data to microprocessor 29. In one embodiment, the reaction torque sensor is mounted between the variable displacement hydraulic motor and the fuselage or pod, (e.g., since the pod is mounted on the fuselage, the pod may be viewed as part of the fuselage).

Analog electrical outputs of reaction torque sensor 36 and position sensor 34 are preferably converted to digital form for microprocessor 29, such as by analog to digital converters.

A hose and drogue system must produce a necessary drag at a predetermined airspeed to allow a refueling probe of a receiver aircraft to engage the drogue. Two common airspeeds are 110 knots for slower aircraft such as helicopters, and 250 knots for faster aircraft, typically fixed wing aircraft. These airspeeds may be used to establish a refueling range. A refueling range typically begins when the receiver aircraft engages the drogue and forces (pushes) hose 22 toward rewind or toward the tanker aircraft approximately five feet. This movement of hose 22 toward the tanker aircraft will be sensed by position sensor 34. Position sensor 34 will send a signal (e.g., a digital signal) to microprocessor 29. When microprocessor 29 receives a signal that hose 22 has been forced (pushed) a required amount by a receiver aircraft, microprocessor 29, by receiving signals from position sensor 34, will monitor whether the receiver aircraft is within an established refueling range. Refueling ranges are different for different aircraft. A helicopter, for example, may have a refueling range of approximately 20 feet while a fixed wing aircraft has a refueling range of approximately 60 feet.

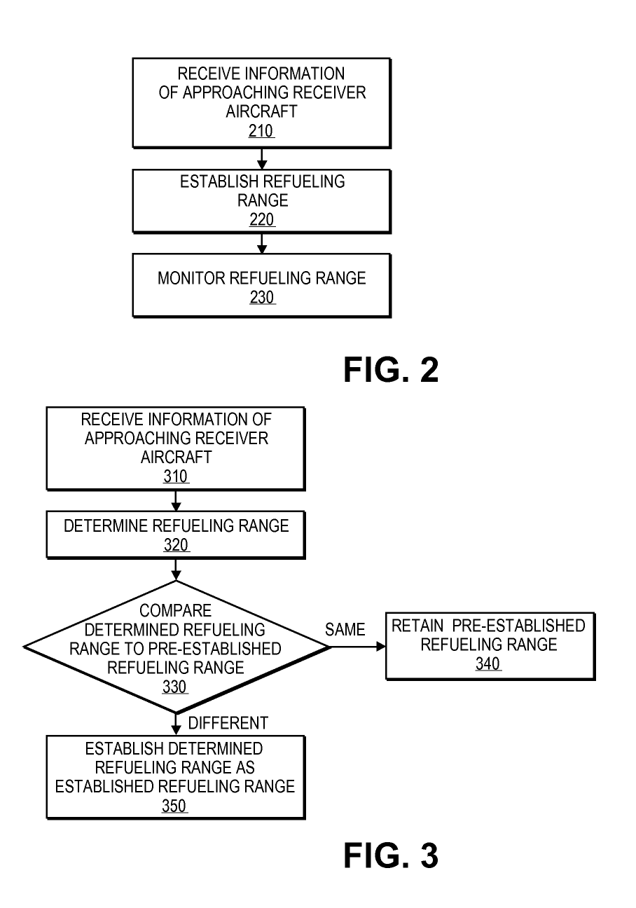

In one embodiment, a machine-readable program is embodied in the microprocessor that includes instructions for controlling a refueling range. The program may be stored on a magnetic medium, optical medium, flash memory device, solid state device, a disc, a CD, or a DVD; and may be copied into the microprocessor and/or main memory (e.g., RAM) for execution by the microprocessor. A method of controlling and monitoring a refueling range is illustrated in FIG. 2. The refueling range may be selected and/or controlled by receiving information about an approaching receiver aircraft, e.g., whether the receiver aircraft is a helicopter, fixed wing aircraft, or a hybrid (e.g., a V22 Osprey). Referring to FIG. 2, microprocessor 29, in the hose reel system described with reference to FIG. 1, of a tanker aircraft receives information about a receiver aircraft approaching the tanker aircraft for a refueling operation (FIG. 2, block 210). The information about the receiver aircraft may identify the refueling airspeed for the receiver aircraft and/or the closing speed of the receiver aircraft relative to the tanker aircraft. The microprocessor may receive this information by manual data entry from an aircrew of the tanker aircraft or from an electronic signal received by the tanker aircraft. Upon receipt of the information, microprocessor 29 establishes (e.g., selects, calculates, and/or is programmed with) a refueling range for the receiver aircraft based on this information. Microprocessor 29 may establish a refueling range by receiving a data signal and, in response to the data signal, selecting or calculating a refueling range. Representatively, microprocessor 29 may selected a refueling range from a lookup table associated with a memory of microprocessor 29, the lookup table storing a number (e.g., two or more) refueling ranges for data representative of the airspeed or closing speed of a receiver aircraft. Microprocessor 29 compares the received data signal with similar data in the lookup and chooses a refueling range when a match is found. The chosen refueling range is then established as the refueling range. Alternatively, microprocessor 29 may calculate a refueling range based on the received data signal. One way a calculation may be performed where a data signal of airspeed of a receiver aircraft is received by a tanker aircraft is to process the airspeed data through an algorithm that multiplies the airspeed data by a frequency factor (e.g., airspeed×0.15-0.1) to compute a refueling range. As one example, a helicopter having an airspeed of 187 feet per second (110 knots) times a frequency factor of 0.1 per second is approximately 20 feet.

Once a refueling range is established, microprocessor 29 may use data received from position sensor 34 indicating the position of the hose (e.g., how far the drogue is extended) to determine whether or not a receiver aircraft is within the refueling range during a refueling operation (FIG. 2, block 230). For example, establishing a refueling range allows microprocessor 29 to establish a threshold or thresholds (e.g., minimum and/or maximum hose length) of when a receiver aircraft is within a refueling range. Microprocessor 29 can compare input data from position sensor 34 to established threshold data. If the data exceeds the threshold data (e.g., is greater than 20 feet for a helicopter), refueling will stop.

In one embodiment, for example, but not limited thereto, the microprocessor is programmed with software (e.g., a program) so that it sends signals to the electro-hydraulic control valve to operate the variable displacement motor typically as follows:

When the hose and drogue are in the stowed position (i.e., hose 22 is completely wound on reel 14) and the tanker aircraft's pilot has not yet deployed the hose and drogue, the microprocessor sends a “neutral” signal to electro-hydraulic control valve 28. The control valve in turn controls the hydraulic pressure so that the motor displacement is zero (i.e., spline shaft may rotate freely).

When the pilot (or avionic equipment) issues a deploy command, the brake is released and the spring ejects the drogue and attached portion of the hose out of the tanker aircraft's fuselage or refueling pod and into the air stream. The reel, in response to the torque imposed on it by the spring through the drogue and hose, rotates in the hose extension direction. The microprocessor continues to send the neutral signal to control valve 28 until microprocessor 29 receives data from position sensor 34 indicating that a first predetermined length of hose has unwound from reel 12, referred to the “initial trail” mode (e.g., three feet).

When the microprocessor receives data from the position sensor 34 indicating that more than 3 feet of hose has unwound from the reel, microprocessor 29 goes into “hose extend” mode and sends signals to the electro-hydraulic control valve which effectively cause the variable displacement hydraulic motor to act as a pump. The drogue, now out of the tanker aircraft's fuselage or refueling pod, is subject to a rearward (i.e., relative to the direction in which the tanker aircraft is traveling) pulling force exerted by the air stream. The reel, in response to the torque imposed on it by the air stream through the drogue and hose, continues to rotate in the hose extension direction. Microprocessor 29 signals the control valve to provide sufficient hydraulic pressure to set the motor's displacement for motor 26 (here acting as a pump) to provide resistance preventing the hose from unwinding from the reel at a linear speed above a nominal hose extension speed (e.g., about 10 feet per second).

Microprocessor 29 continues to monitor the hose length data (i.e., data relating to the length of hose unwound from the reel) based on signals received from position sensor 34. When microprocessor 29 receives data from position sensor 34 indicating that a second predetermined length of hose (including the first predetermined length) has unwound from reel 12, the microprocessor signals control valve 28 to increase the hydraulic pressure to a level which sets the motor's displacement such that the motor exerts sufficient torque, through spline shaft 30 and gear box 31, on reel drive shaft 16 to completely resist the force imparted by the air stream on the drogue and hose and bring the rotation of reel 12 to a halt (with some hose still remaining on the reel). The microprocessor may be referred to as being in the “full trail” mode. The second predetermined length will vary widely depending mostly on the type of tanker aircraft on which the refueling system is mounted. For purpose of illustration, 50 feet will be used to exemplify the second predetermined length. While in the full trail mode, microprocessor 29 signals the control valve to maintain the hydraulic pressure such that the resistance torque maintains the extended hose length at 50 feet.

At the time that the hose length has been maintained at 50 feet (i.e., the hose speed equals zero (0) feet per second) for a period of time (e.g., five seconds), microprocessor 29 goes into “pre-engagement” mode. The microprocessor continues, in response to data received from the position sensor 34, to send signals to the control valve to maintain the hose extension at 50 feet. Reaction torque sensor 36 measures a reaction torque on the reel and reel drive shaft exerted by the air stream pulling on the drogue and hose. The reaction torque sensor 39 sends data representing that force, referred to as the “free trail drag torque,” to microprocessor 29.

At this point in time, a “READY” signal is transmitted to the pilot of the receiver aircraft, and that pilot begins his or her aircraft's run at the drogue.

If the receiver aircraft's probe successfully engages the drogue, microprocessor 29 goes into the “engagement” mode. The microprocessor continues to monitor the reaction torque data from reaction torque sensor 36, which now is measuring the reaction torque on reel 12 and reel drive shaft 16 as a result of the net force resulting from the force exerted by the air stream pulling on the drogue plus or minus the force exerted on the drogue by the refueling probe (depending upon whether the receiver aircraft is moving slower or faster than the tanker aircraft). The amplitude of this reaction torque may be referred to as “net drag torque.” Because the receiver aircraft must be traveling at a speed somewhat faster than the tanker aircraft's speed to achieve engagement of the fuel probe with the drogue, the net drag torque will be less than the free trail drag torque during the initial engagement of the probe with the drogue. During initial engagement it is desirable to have the refueling probe exert significant force against the drogue so as to assure proper engagement of the probe and drogue. Therefore, during initial engagement it is concomitantly undesirable to have the motor 26 cause retraction of the hose and drogue. So, in response to data from reaction torque sensor 36 regarding the net drag torque, microprocessor 29 signals the control valve to decrease the hydraulic pressure to decrease the motor's displacement, and therefore the motor's torque output at spline shaft 30 so as to keep the hose speed at zero as the receiver aircraft pushes the drogue forward.

After initial engagement, the hose starts to retract and microprocessor 29 then enters the “refueling” mode. Refueling (i.e., pumping of fuel from the tanker aircraft to the receive aircraft) will begin. By monitoring the signals from sensors 34 and 36, microprocessor 29 will continue to determine the signals it needs to send to the control valve to hold the hose speed at zero so long as the net drag torque, for example, is between 80% and 90% of the free trail drag torque, and send such signals to control valve 28. The receiver aircraft's pilot will attempt to maintain the speed of the receiver aircraft the same as the speed of the tanker aircraft. To the extent if any that the two aircraft's speeds vary from each other such that the net drag torque is outside the 80-90% of free trail drag torque range, microprocessor instructions will cause the motor to act as a motor or pump, refracting or allowing extension of the hose.

While the microprocessor is in the refueling mode, actual refueling will stop if an established refueling range (hose length) is exceeded (i.e., if the hose length changes by more than the threshold amount established by microprocessor 29 (see, e.g., FIG. 2)) and may restart when the receiver aircraft is a predetermined marginal amount of the third predetermined length). For example, if microprocessor 29 establishes a refueling range of 20 feet for a helicopter as the receiver aircraft and the receiver aircraft forces (pushes) the hose and drogue more than 20 feet (e.g., 21 feet or more) in the retract direction, refueling will stop. It is appreciated that, during refueling, a receiver aircraft may be in or out of a refueling range regardless of whether electro-hydraulic control valve 28 maintains a hose speed of zero for an acceptable net drag torque (e.g., a net drag torque between 80% and 90% of the free trail drag torque). In other words, a hose that is maintained at a particular tension (e.g., by a reaction torque on reel 12) to maintain a hose in a full trail mode, may still be pushed by a receiver aircraft into and out of an established refueling range.

A tanker aircraft may include an illumination system characterized by lights that illuminate a particular color to inform a pilot of a receiver aircraft of a refueling operation. For example, an illumination system may be connected to the tanker aircraft near the hose reel. Fuel flow is typically indicated by illumination of a green light on the tanker aircraft. If the hose is pushed in too far or not far enough, a cutoff switch will inhibit fuel flow, which is typically accompanied by a red light. In one embodiment, the light system is connected to microprocessor 29 and microprocessor controls which color is illuminated based on data received from position sensor 34 (in the case of a green light or red light).

When refueling is complete, the receiver aircraft's pilot reduces the speed of the receiver aircraft relative to the tanker aircraft. The microprocessor remains in the refueling mode and, since the net drag torque will exceed 90% of the free trail drag force, the microprocessor will be sending signals to the control valve which cause the motor's displacement to be set such that the motor acts as a pump. The microprocessor stays in the refueling mode until it receives hose length data indicating that the hose length is within five feet from the second predetermined length (50 feet in the example discussed herein).

When the hose is at the second predetermined length then the microprocessor sends signals to the control valve which cause the valve to increase the hydraulic pressure, thereby increasing the resistance torque, until the hose extension speed approaches zero. When the microprocessor receives data from position sensor 34 indicating that the second predetermined length of hose has unwound from reel 12, the microprocessor signals the control valve to increase the hydraulic pressure and the motor's displacement to a level which causes the motor to exert sufficient torque, through spline shaft 30 and gear box 31, on reel drive shaft 16 to completely resist the force imparted by the air stream and the probe on the drogue, and bring the rotation of reel 12 to a halt (with, as discussed above, several turns of hose still remaining on the reel). By the time that the reel is brought to a halt, the probe has disengaged from the drogue.

The microprocessor, still monitors the hose length and reaction torque data, and, depending upon a tanker aircraft cockpit command, either (i) returns to the beginning of the full trail mode to start the refueling process for another receiver aircraft or (ii) enters the “retraction” mode and issues signals to the control valve which result in the motor outputting sufficient torque to cause the hose to be wound upon the reel at up to a second predetermined retraction speed, which in this example is 10 linear feet per second. When the microprocessor receives hose length data indicating that the hose length is approaching the first predetermined length (3 feet in the example discussed herein), the microprocessor sends signals to the control valve which cause the valve to decrease the hydraulic pressure, which decreases the motor's displacement, thereby resulting in a decrease in the hose retraction speed. The microprocessor continues sending signals causing retraction of the hose until the drogue contacts and compresses the ejection spring and the hose length data indicates that hose extension length is zero, with the motor's displacement set at zero.

FIG. 3 illustrates another embodiment of controlling a refueling range. In this embodiment, the refueling range may be changed from a first refueling range to a second refueling range. An example of a change in refueling range may arise when a tanker aircraft is asked to refuel aircraft having different airspeeds (e.g., a helicopter and a fixed wing aircraft). Similar to FIG. 2, the refueling range may be controlled by receiving information about an approaching receiver aircraft, e.g., whether the receiver aircraft is a helicopter or fixed wing aircraft. Referring to FIG. 3, a microprocessor (such as microprocessor 29 in the hose reel system described with reference to FIG. 1) of a tanker aircraft receives information about a receiver aircraft approaching the tanker aircraft for a refueling operation (block 310). The information identifies the refueling airspeed for the receiver aircraft and/or the closing speed of the receiver aircraft relative to the tanker aircraft. The microprocessor may receive this information by manual data entry from an aircrew of the tanker aircraft or from an electronic signal received by the tanker aircraft. Upon receipt of the information, the microprocessor determines (e.g., selects, calculates) a refueling range for such an aircraft based on this information (e.g., determines whether the refueling range should be 20 feet or 60 feet) (block 320)). The microprocessor then compares the determined refueling range to a pre-established refueling range (block 330). If the determined refueling range is the same as the pre-established refueling range, the microprocessor maintains the refueling range at the pre-established range. If the refueling range is different than the pre-established refueling range, the microprocessor may establish (e.g., select, calculate) the determined refueling range as the established refueling range (i.e., change the established refueling range to the determined refueling range). Once a refueling range is established (at either the pre-established or the determined refueling range), the microprocessor may use data received from, for example, a position sensor associate with a hose (e.g., position sensor 34 associated with hose 22 in the hose reel system of FIG. 1) to indicate the position of the hose (e.g., how far the drogue is extended) to determine whether or not a receiver aircraft is within the refueling range during a refueling operation.

The embodiment of a hose reel drive system and methods described above establish a refueling range via a microprocessor (controller) in a tanker aircraft. A refueling range may be established or changed by data supplied to the microprocessor without on the ground adjustments required of prior art systems. Further, a refueling range established by the microprocessor is limited only by the available hose length associated with the hose reel drive system. Rather than the options of a 20 foot refueling range for a helicopter and a 60 foot refueling range for a fixed wing aircraft, establishing a refueling range at a microprocessor that controls a hose reel drive system provides an ability to set a refueling range at many different settings (e.g., 25 feet, 30 feet, 55 feet, 65 feet, etc.).

A hose may also include physical markers (e.g., color bands) at various points along its length to alert a pilot of a refueling range. For example, a hose may include a first marker that is visible to a receiver aircraft that would perform a refueling operation at a slower speed (110 knots). When the receiver aircraft forces the hose toward the tanker aircraft so that the marker is no longer visible to the receiver aircraft, the refueling range is exceeded. The hose might also include markers (e.g., bands) of different colors visible to receiver aircraft that can perform a refueling operation at faster airspeeds with the markers spaced according to a variety of refueling rangers. A pilot of a receiver aircraft may be instructed to monitor a particular colored marker to stay within an established refueling range.

In the preceding detailed description, reference is made to specific embodiments thereof. It will, however, be evident that various modifications and changes may be made thereto without departing from the broader spirit and scope of the following claims. The specification and drawings are, accordingly, to be regarded in an illustrative rather than a restrictive sense.

What is claimed is:

1. In an aerial refueling system for refueling a receiver aircraft in flight from a tanker aircraft, wherein the refueling system includes a hose reel rotatably coupled to the tanker aircraft's fuselage, a hose wound around the reel, said hose having an outlet end, and a drogue affixed to said outlet end, a hose reel drive system comprising:
a microprocessor electrically coupled to the reel; and
a machine-readable program stored on a medium, that when executed by a microprocessor directs operation of an aerial refueling system, the machine-readable program comprising:
instructions for establishing a refueling range.

2. The aerial refueling system of claim 1, wherein the machine-readable program further comprises instructions for changing the refueling range to a different refueling range in response to a condition.

3. The aerial refueling system of claim 2, wherein the condition comprises a projected air speed of a receiver aircraft.

4. The aerial refueling system of claim 2, wherein the condition comprises a closing speed of a receiver aircraft relative to the tanker aircraft.

5. The aerial refueling system of claim 1, further comprising a position sensor coupled to the reel and the machine-readable program further comprises instructions for determining whether a receiver aircraft is within an established refueling range based on data received from the position sensor.

6. A method comprising:
receiving information of a receiver aircraft for aerial refueling at a microprocessor; and
establishing, in flight, a refueling range for an aerial refueling system coupled to a tanker aircraft based on the received information.

7. The method of claim 6, wherein establishing a refueling range comprises changing a first refueling range to a second different refueling range.

8. The method of claim 6, wherein a refueling range is established based on a predetermined air speed of the receiver aircraft during refueling.

9. The method of claim 6, wherein a refueling range is established based on a closing speed of the receiver aircraft relative to the tanker aircraft.

10. The method of claim 6, wherein establishing a refueling range comprises providing data to a microprocessor that controls a hose reel.

11. A machine-readable program stored on a medium, that when executed by a microprocessor directs operation of an aerial refueling system, the machine-readable program comprising:
instructions for establishing a refueling range.

12. The machine-readable program of claim 11, wherein the machine-readable program further comprises instructions for changing the refueling range to a different refueling range in response to a condition.

13. The machine-readable program of claim 11, wherein the condition comprises a projected air speed of a receiver aircraft.

14. The machine-readable program of claim 11, wherein the condition comprises a closing speed of a receiver aircraft relative to the tanker aircraft.
